(19) United States
(12) Patent Application Publication
(10) Pub. No.: US 2016/0139877 A1
(43) Pub. Date: May 19, 2016

(54) VOICE-CONTROLLED DISPLAY DEVICE AND METHOD OF VOICE CONTROL OF DISPLAY DEVICE

(71) Applicant: NAM TAE PARK, Daejeon (KR)

(72) Inventor: NAM TAE PARK, Daejeon (KR)

(21) Appl. No.: 14/931,302

(22) Filed: Nov. 3, 2015

(30) Foreign Application Priority Data
Nov. 18, 2014 (KR) 10-2014-0160657
Feb. 10, 2015 (KR) 10-2015-0020036
Jul. 19, 2015 (KR) 10-2015-0102102

(51) Int. Cl. G06F 3/16; G10L 15/22

(52) U.S. Cl. CPC G06F 3/167; G10L 15/22; G10L 2015/223

(57) ABSTRACT

The present invention is to provide a voice-controlled display device configured such that the inputted user's speech is compared with the identification voice data assigned to each of the execution unit areas on a screen displayed through a display unit and, if there exists identification voice data corresponding to the user's speech, an execution signal is generated to the execution unit area to which the identification voice data is assigned to resolve the inconvenience that the user needs to learn the voice commands stored in the database and to apply the convenience and intuitive simplicity of user experience (UX) of the conventional touchscreen control to the voice control, and a method of voice control of the above display device

### CROSS-REFERENCE TO RELATED APPLICATION(S)

This application claims the benefit of Korean Patent Application No. 10-2015-0102102, filed on Jul. 19, 2015, based on Korean Patent Application No. 10-2014-0160657, filed on Nov. 18, 2014, and Korean Patent Application No. 10-2015-0020036, filed on Feb. 10, 2015, which ace hereby incorporated by reference herein in its entirety.

### BACKGROUND

1. Technical Field

The present invention relates generally to a voice-controlled display device and a method of voice control of the display device. More particularly, the present invention relates to a voice-controlled display device configured such that an inputted speech of a user is compared with identification voice data assigned for each of execution unit areas on a screen displayed by a display unit and, if there exists an identification voice data corresponding to the user's speech, an input signal is generated for the execution unit area to which the identification voice data is assigned, and to a method of voice control of the above display device

2. Description of the Related Art

In recent years, with the release of a variety of smart appliances, display devices become multifunctional and highly advanced. Also, various input systems have been developed to control the display devices, such as a motion sensing remote controller and a touchscreen as well as conventional methods such as a mouse, a keyboard, a touchpad, a button type remote controller and so on. Among these various input systems, a voice control system in which user's speech is recognized to control the display device more easily is in the spotlight recently.

The voice control speech recognition is widely applied to smartphones, tablet PCs. and smart TVs, which are recently commonly used: however, for the application of the voice control, support for newly installed application has not substantially been made. Also, even in the case of built-in-applications, the inconvenience that a user should learn the voice commands stored in a database has been pointed out as a problem. That is, a voice control system that is satisfying in terms of user convenience has not been introduced yet.

### SUMMARY

An object of the present invention is to resolve the problems, such as difficulties in supporting the voice control in the case of applications newly installed in addition to built-in applications, and difficulties in supporting the voice control in various languages; and the inconvenience that the user should learn the voice commands stored in the database as described above, and further to apply the convenience and intuitive simplicity of user experience (UX) of the conventional touchscreen control to the voice control. In order to achieve these objects, the present invention provides a voice-controlled display device configured such that an inputted speech of a user is compared with identification voice data assigned to each of the execution unit areas on a screen displayed through a display unit and, if there exists identification voice data corresponding to the user's speech, an execution signal is generated to the execution unit area to which the identification voice data is assigned, and a method of voice control of the above display device

In particular, the present invention has been made to solve the following problems in the case that an input is made by a user's speech in the above-described voice-controlled, display device.

1. Only an input in a system default language is available.

For example, it is as shown in FIGS. 6-8 Which will be described later. It is assumed that the system default language is Korean. In FIG. 6, when a user presses a microphone shape in the right upper corner of the screen, the screen is switched over to the one shown in FIG. 7. At this time, if the user utters “American”, the system presents the screen of FIG. 8 as a result of the input and the speech recognition. That is, the search result is for the Korean word “ [symbol] ” with the same pronunciation as “American”. However, if the user wanted to input an English word “American”, such a speech input is not available.

2. There is no means for preventing input error in the case of homonyms.

For example, in the case that a user pronounces “e” in FIG. 9, it cannot be determined if the user tried to utter the number “2” as the Korean vowel “ [symbol] ”, the Korean word “ [symbol] ” (lee), or the English letter “e” of FIG. 10. Accordingly, it is very likely to cause a speech recognition error, which gives inconvenience to the user.

3. Voice input of various symbols (“,”, “.”, “?”, “@”, etc.) is not easy.

For example, even in the case that a user learns the matchings of the content to be pronounced and those to be inputted in advance such as “,” and “comma”, if the user utters “comma”, it is difficult to determine whether the user tries to input the symbol “,” or the word “comma”. The user sometimes tries to input the symbol “,” and the user tries to input the word “comma” for other times.

To achieve the above-described objects, the present invention has the following features.

The present invention provides a voice-controlled display device which comprises a display unit and a memory unit with a database, in which an identification voice data, stored thereon, is assigned and mapped to each of execution unit areas an a screen displayed through the display unit.

The present invention may be characterized by further comprising an information processing unit for generating the identification voice data through text-based speech synthesis using text in case that there exists text for each of the execution unit areas on the screen displayed through the display unit.

The present invention may be characterized by thriller comprising a communication unit connectable to the Internet, wherein, in the case that a new application including identification voice data is downloaded and installed in the display device, the display unit generates an execution unit area for the newly installed application, the identification voice data included in the application is classified in the information processing unit, and the database stored in the memory unit stores the generated execution unit area and the distinguished identification voice data which are assigned and mapped.

The present invention may be characterized by further comprising: a speech recognition unit for receiving input user's speech, wherein, in the case that the speech recognition unit receives user's speech, the information processing unit searches the database and determines whether there exists identification voice data corresponding to the user's speech:, and a control unit for generating an execution signal for a corresponding execution unit area in the case that there exists an identification voice data corresponding to the user's speech as a result of the determination of the information processing unit.

Furthermore, the present invention may be characterized in that the identification voice data generated by the information processing unit may be generated by applying a speech synthesis modeling information to the user's utterance.

Here, a control voice data corresponding to a control command for performing a specific screen control and an execution control corresponding to the execution unit area, to which an identification voice data is assigned if it is combined and used with the identification voice data, may be stored additionally in the database; in the case that the speech recognition unit receives a user's speech, the information processing unit searches the database and determines that there exist an identification voice data and a control voice data corresponding to the user's speech; and, in the case that there exist an identification voice data and a control voice data corresponding to the user's speech as a result of the determination of the information processing unit, the control unit generates an execution signal in an execution unit area to which the corresponding identification voice data is assigned and executes the control command corresponding to the control voice data corresponding to the execution unit area which generated the execution signal.

In addition, the present invention may be characterized in that the identification voice data stored in the memory unit is stored by phoneme.

Furthermore, the present invention may be characterized in that, when the information processing unit determines whether there exists an identification voice data corresponding to the user's speech, the received user's speech is divided by phoneme and compared.

Meanwhile, the present invention provides a method of voice control of a voice-controlled display device comprising a display unit, a memory unit, a speech recognition unit, an information processing unit, and a control unit, which comprises the step of (a) storing an identification voice data which is assigned and mapped to each of execution unit areas on a screen displayed through the display unit in the memory unit in a database.

The method of the present invention may further comprise the step of (b) generating an identification voice data through a text-based speech synthesis using text in the case that there exists text for each of the execution unit areas on the screen displayed through the display unit by the information processing unit.

Additionally, the method of the present invention may further comprise the steps of:

(c) receiving an input of a user's speech by the speech recognition unit;

(d) searching the database and determining whether there exists an identification voice data corresponding to the user's speech by the information processing unit; and

(e) generating an execution signal for the execution unit area to which the corresponding identification voice data is assigned by the control unit in the case that there exists an identification voice data corresponding to the user's speech as a result of the determination of the information processing unit.

Here, the step (a) may be performed such that a control voice data corresponding to a control command for performing a specific screen control and an execution control corresponding to the execution unit area, to which an identification voice data is assigned if it is combined and used with the identification voice data is stored additionally in the database in the memory unit;

the step (d) may be performed such that the information processing unit searches the database and determines whether there exist an identification voice data and a control voice data corresponding to the user's speech; and

the step (e) may be performed such that, in the case that there exist an identification voice data and a control voice data corresponding to the user's speech as a result of the determination of the information processing unit, the control unit generates an execution signal in an execution unit area to which the corresponding identification voice data is assigned and executes the control command corresponding to the control voice data corresponding to the execution unit area which generated the execution signal.

In addition, the identification voice data stored in the memory unit in the step (a) may be stored by phoneme, and, when the information processing unit determines that there exists an identification voice data corresponding to the user's speech in the step (d), the received user's speech may be divided by phoneme and compared.

The voice-controlled display device and the method of voice control of the display device according to the present invention have the following advantages.

1. It is highly convenient since identification voice data for newly installed applications is automatically generated and stored as well as for the default built-in application to support voice control.

2. It allows users to perform voice control conveniently without the need of learning voice commands.

3. Voice control in various languages is supported only by an installation of a language pack for a text-based speech synthesis.

4. Simple and accurate voice control is achieved as an input control system of a conventional touchscreen and is directly applied by comparing voice data assigned to each of the execution unit areas on a screen displayed by the display unit to the inputted user's speech to thereby perform a voice control.

5. It is possible to provide an alternative interface to a touchscreen for wearable devices, or virtual reality headsets (VR devices) in which implementation and operation of a touchscreen are challenging. Also, an interface for beam projectors loaded with a mobile operating system offering a touchscreen type user experience (UX) can be provided.

6. In the case that execution unit areas are configured by a virtual keyboard, not only the system default language but also various languages, numbers, symbols and so on can be inputted. In a screen as shown in FIGS. 9 and 10, an input signal is generated in each of the execution unit areas of the virtual keyboard based on the contents of user's utterance, and the user may input using his/her voice like everyday conversation.

7. When the execution unit area are configured by a virtual keyboard, input errors of homonyms can be prevented.

FIGS. 9 and 10 illustrate an embodiment in which a virtual keyboard is provided with a virtual keyboard layout such as one having a Korean English switch key English/Korean switch key, symbol switch key, number switch key and the like. In some cases, a modified embodiment designed to display the Korean/English switch key. English/Korean switch key, symbol switch key, number switch key, and so on in the same screen is available. To prevent input errors of homonyms, if a user tries to input Korean vowel “ [symbol] ”, he or she can change the input language state of the virtual keyboard to the Korean input mode by input of “Korean/English switch” in advance.

Similarly, if the user wants to input the English alphabet “e”, lie or she can first change the input language state of the virtual keyboard to the English input mode by input of “Korean/English switch” and then uttering input speech. Symbols and numbers can be inputted in the same manner.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows an exemplary home screen of a smartphone according to an embodiment of the present invention.

FIG. 2 shows an application loading screen when ‘GAME’ is executed in the home screen of FIG. 1.

FIG. 3 is an execution screen of ‘My File’ of a smartphone according to an embodiment of the present invention.

FIG. 4 shows an embodiment when an identification voice data and a control command are executed in ‘Video’ of ‘My File’ according to an embodiment of the present invention.

FIG. 5 is a flow diagram of an execution process according to the present invention.

FIG. 6 is a search screen for the Google YouTube app of a smartphone according to an embodiment of the present invention.

FIG. 7 is a speech reception standby screen when a speech recognition input is executed on the screen of FIG. 6.

FIG. 8 is a resulting screen when a user says “American” in FIG. 7, and the speech of the user is recognized and searched.

FIG. 9 is an embodiment in which a virtual keyboard is rendered in the case that the language to be inputted to a search window is Korean according to an embodiment of the present invention.

FIG. 10 is an embodiment in which a virtual keyboard is rendered in the case that the language to be inputted to a search window is English according to an embodiment of the present invention.

### DETAILED DESCRIPTION

Now a voice-controlled display device and a method of voice control of the display device according to the present invention is described in detail with reference to the specific embodiments in the following.

1. Voice-controlled display device

A voice-controlled display device according to the present invention is a voice-controlled display device having a display unit, which comprises:

a memory unit with a database, in which an identification voice data is assigned and mapped to each of the execution unit areas on a screen displayed through the display unit, and is stored thereon; an information processing unit for generating the identification voice data through text-based speech synthesis using text in the case that there exists text for each of the execution unit areas on the screen displayed through the display unit, a speech recognition unit for receiving an input of a user's speech; an information processing unit for searching the database and determining whether there exists an identification voice data corresponding to a user's speech, in case that the speech recognition unit receives the user's speech; and a control unit for generating an execution signal for a corresponding execution unit area in the case that there exists an identification voice data corresponding to the user's speech as a result of the determination of the information processing unit. The voice-controlled display device having the above configuration according to the present invention may be implemented in all voice control display devices including smartphones, tablet PCs, smart TVs, and navigation devices, which are already widely used, as well as wearable devices such as smart glasses, smart watches, and virtual reality headsets (VR devices) and so on.

The touchscreen input system which is widely applied and used in smartphones, tablet PCs, etc. is a very intuitive input system in a GUI(Graphic User Interface) environment, which is very convenient to use.

The present invention is characterized by applying a conventional voice control method, in which a voice command and a specific execution substance correspond one-to-one, to a touchscreen type user experience (UX) for voice control of a display device.

In addition, according to the present invention, identification voice data is generated on the basis of the text displayed on the screen through a text-based speech synthesis. Accordingly, it does not need to store the identification voice data in advance or record user's speech. Also, it supports newly downloaded and installed applications as well as already built-in applications.

Furthermore, it supports voice control in various languages by merely installing a language pack for a text-based speech synthesis on a voice-controlled display device of the present invention.

In the present invention, the execution unit area has a concept corresponding to a contact area on which a touchscreen and a touching means (for example, fingers, capacitive sensing touch pen, etc.) make contact with each other in a touchscreen input method, which refers to a range in which an input signal and an execution signal are generated on a screen displayed through the display unit and which is a specific area comprising a plurality of pixels. In addition, it includes delineating an area resulting in the same outcome in which an input signal or an execution signal can be generated on any pixel in that area. The examples include various menu GUI etc. on a screen displayed on a display unit of a smartphone in the following embodiments and drawings. It may also include virtual grid areas of matrix type in which shortcut icons of applications are arranged though this it not illustrated in the drawings. Also, it is variable in its size, number, shape, or arrangement according to a screen, since it corresponds to the contact areas of the touchscreen and the touch means in the touchscreen input method, as described above. Identification voice data may mean identification information used for user's voice comparison.

Also, the present invention is characterized in that an identification voice data is generated through a text-based speech synthesis (e.g. TTS; Text To Speech). Generally, TTS (Text To Speech) technology is used to synthesize text into voice data and replay the generated voice data to a user to have the effect of reading the text out loud. According to the present invention, instead of replaying the generated voice data, it is utilized as identification voice data and the identification voice data are automatically updated and stored during an update such as a download of new applications.

In a conventional speech synthesis technology, more natural sound is synthesized through the processes of pre-processing, morphological analysis, parser, grapheme-to-phoneme conversion, prosodic symbol creation, synthesis unit selection and pause creation, phoneme duration processing, intonation control, synthesis units database, synthesis creation (e.g. Articulatory synthesis, Formant synthesis, Concatenative synthesis, etc.) and so on. In the present invention, ‘speech synthesis modeling information based on user utterance’ means the information updated when the speech recognition unit receives a user's speech and a voice command and the information processing unit and the memory unit analyze the user's speech to obtain and update the synthesis rules, phoneme, etc. used in the processes of the above speech synthesis.

If identification voice data is generated using this speech synthesis modeling information based on user utterance, the rate of speech recognition may be highly increased.

If a voice-controlled display device according to the present invention is a smartphone, to further increase the rate of speech recognition, user's speech during the user's ordinary phone calls are received by the speech recognition unit and the synthesis rules, phoneme, etc. are obtained and updated for updating the speech synthesis modeling information based on user utterance.

The memory unit is implemented as a memory chip embedded in a voice control display device such as smartphones, tablet PCs, and so on. The database has identification voice data which is assigned to be mapped to each of execution unit areas on a screen displayed through the display unit. Specifically, it includes unique coordinate information given by area which is recognized as the same execution unit area on the screen.

The speech recognition unit is used to receive a user's speech and it is implemented as a microphone and a speech recognition circuit embedded in various voice-controlled display device.

The information processing unit and the control unit are implemented as a CPU, a RAM and control circuits such as those embedded in various voice-controlled display devices. The information processing unit serves to generate identification voice data through a text-based speech synthesis using a text present for each of the execution unit areas displayed via the display unit and to search the database to determine whether there is an identification voice data corresponding to a speech of the user when the speech recognition unit receives the user's speech. More specifically, if there is an identification voice data corresponding to the speech of the user, then it detects a unique coordinate information of the execution unit area to which the corresponding identification voice data is assigned. In addition, the control unit serves to generate an input signal to the execution unit area to which the identification voice data is assigned if there is the identification voice data corresponding to the user's speech according to the determination result of the information processing unit, and the execution signal is generated in the area on the screen having the coordinate information detected by the information processing unit. The result of the generation of the execution signal varies depending on the substance of the execution unit area. If the execution unit area is a shortcut icon of the specific application, the application is executed. If the execution unit area is a virtual keyboard GUI of the specific character of the virtual keyboard, then the specific character is inputted. If a command such as screen switchover is assigned to the execution unit area, the command is performed.

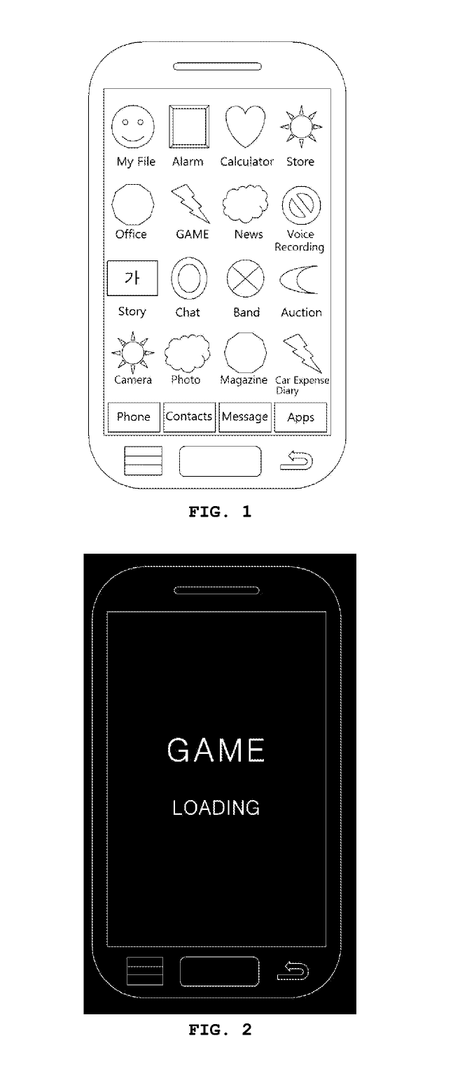

Furthermore, in some cases, no execution is performed. This is the case in which any icon, virtual keyboard, or specific command is not assigned to the execution unit area. The reason why such execution unit area is delineated on the screen displayed through the display rant and the identification voice data is assigned, mapped, and stored is that this allows high extensibility in the case that as control command is assigned to perform a specific screen control and an execution control corresponding to the execution unit area to which an identification voice data is assigned when a control voice data and an identification voice data are combined and used. Though it is not illustrated, for example, FIG. 1 can be divided into execution unit areas of 5 rows and 4 columns and an identification voice data of an alphabetical order from the left uppermost area can be designated. Then, the execution unit area of the “News” application is assigned an identification voice data of “G”, and the execution unit area of the “Game” application is assigned an identification voice data of “F”. In the case that the control voice data of “Zoom In” command is assigned to the control command, if it is used with the identification voice data “G” such as “Zoom In G”, then it is possible to have a configuration in which a Zoom In command is performed to enlarge the screen on the basis of “G”. Accordingly, even fix the case in which there is no command that can be performed only with the identification voice data which is assigned and mapped to the execution unit area, the area is delineated as an execution unit area, and an identification voice data is assigned, mapped, and stored in the database taking extensibility into consideration. That is, it is the same manner as when a touchscreen is used, and there is no need to assign an executable command for the execution unit area.

As a specific embodiment, FIG. 1 shows an exemplary home screen of a smartphone according to an embodiment of the present invention. FIG. 2 shows an application loading screen when “GAME” is executed in the home screen of FIG. 1. If a user wants to execute the “GAME” application through a touchscreen operation, he or she can touch “GAME” on the screen.

In the present invention, this process is implemented in a manner of voice control.

Specifically, as shown in FIG. 1, execution unit areas (application execution icons) on the screen displayed through the display unit are established. Using the text tendered by the execution unit area (names of the application icons shown in FIG. 1), identification voice data is generated in the information processing unit through a text-based speech synthesis. It is assumed that the database in which identification voice data generated in the information processing unit for each of the execution unit areas that are assigned and mapped is stored in the memory unit. If a home screen is displayed in the display unit and a user's speech of “GAME” is inputted through the speech recognition unit, the information processing unit searches a database for the home screen and determines whether there is an identification voice data corresponding to the user's speech of “GAME”. In the case that the information processing unit found the identification voice data of “GAME” which corresponds to the user's speech of “GAME”, the control unit generates an execution signal to the “GAME' application icon which is an execution unit area to which the corresponding identification voice data is assigned. As a result, an application screen as shown in FIG. 2 is executed.

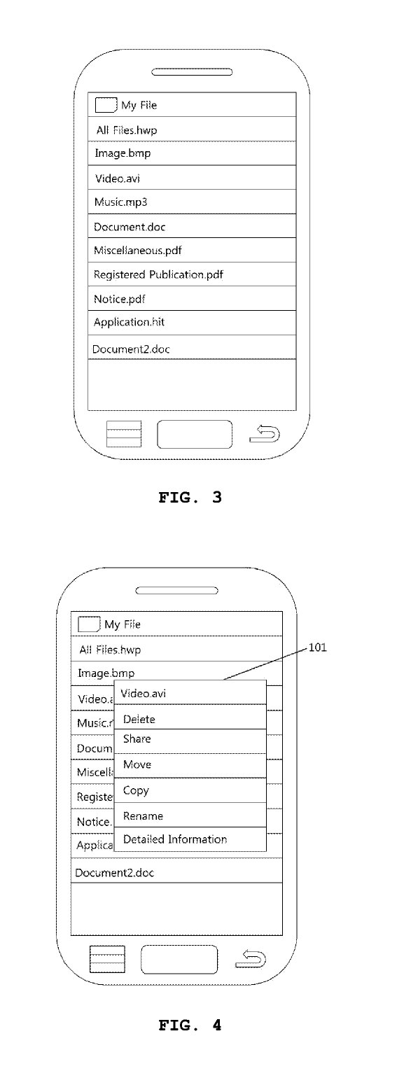

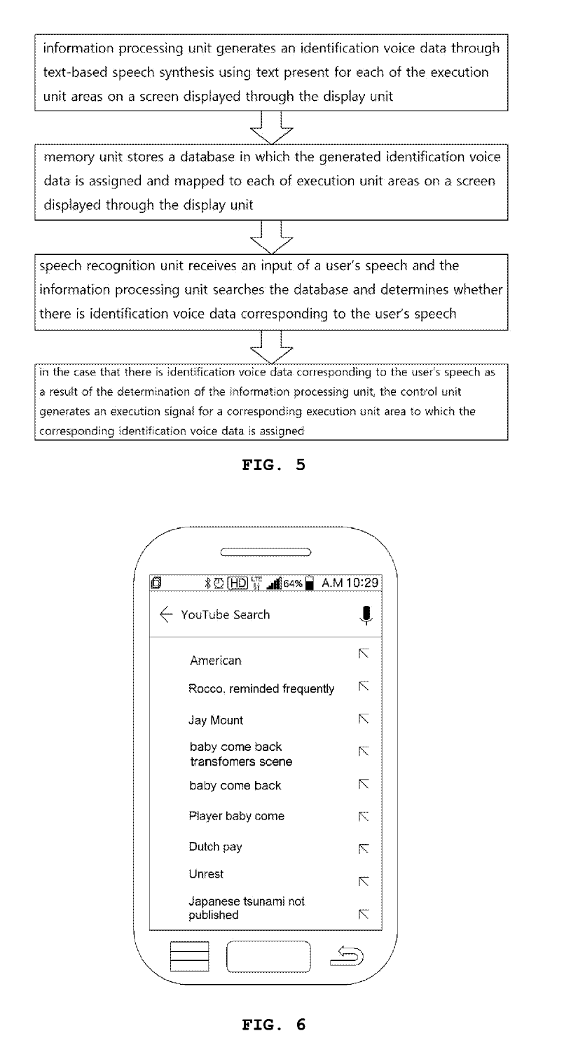

Also, it is assumed that a new icon of “My File” application in FIG. 1 is downloaded and installed, and an identification voice data of “My File” is included in the installation program code of the “My File” application. Then, the information processing unit distinguishes the identification voice data of “My File” and generates an execution unit area of the “My File” icon application shown in the first row of the first column in FIG. 1. The memory unit stores the database in which the generated execution unit area and the distinguished identification voice data are assigned and mapped. When a home screen is displayed in the display unit and a user's speech of “My File” is inputted through the speech recognition unit, the information processing unit searches the database for the home screen and determines whether there is an identification voice data corresponding to the user's speech of “My File”. If the information processing unit finds the identification voice data of “My File” which corresponds to the user's speech of “My File”, the control unit generates an execution signal to the “My File” application icon which is the execution unit area to which the corresponding identification voice data is assigned. As a result, an application is executed as shown in FIG. 3.

Also, a control voice data corresponding to a control command for performing a specific screen control and an execution control which correspond to the execution unit area, to which the identification voice data is assigned if it is combined and used with the identification voice data, is stored additionally. If the speech recognition unit receives a user's speech, the information processing unit searches the database and determines whether there are identification voice data and control voice data corresponding to the user's speech. If it is determined that there are identification voice data and control voice data corresponding to the user's speech according to the determination result of the information processing unit, the control unit generates an execution signal to the execution unit area to which the corresponding identification voice data is assigned and also executes a control command corresponding to the control voice data which corresponds to the execution unit area which generates the execution signal.

A specific embodiment in which identification voice data and control voice data are combined and used is illustrated in FIGS. 3 and 4. The embodiment of FIG. 4 assumes that a screen displayed through the display unit on the screen of FIG. 3 is divided into execution unit areas made of 11X1 matrix, an identification voice data generated through a text-based speech synthesis using the text present in each of the execution unit areas is assigned to each of the execution unit areas, and a control voice data of “Menu” is additionally stored as an executable menu activation control command for the file in the database. In FIG. 3, if a user inputs voice commands of “Menu” and “Video” in succession, the control unit displays the execution unit area of “Video.avi” (which corresponds to the fourth row of the first column) on the screen and the executable menu 101 for the file on the screen (See FIG. 4). Also, it is possible to configure how the chronological sequence of user's input audio commands of “Video” and “Menu” is processed. That is, it is possible to have a configuration such that the order in which the control voice data and identification voice data are combined is irrelevant.

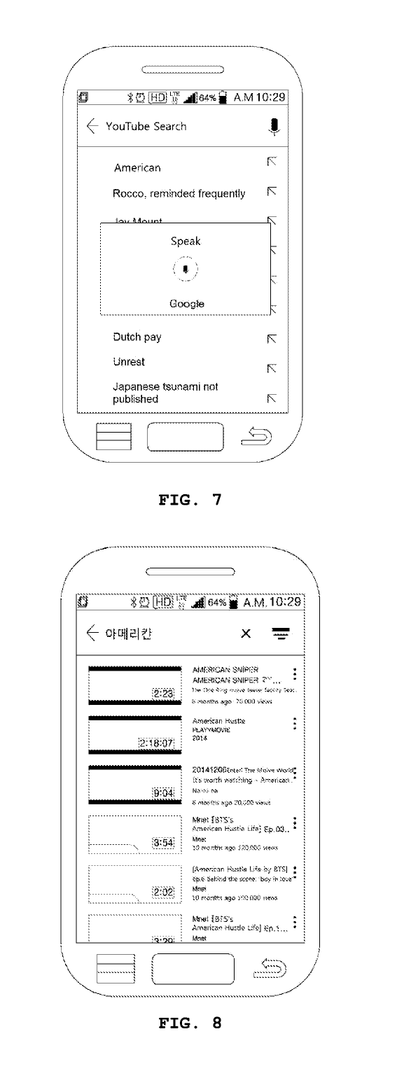

In addition, another embodiment according to the present invention is that each key of a virtual keyboard is marked off as an independent execution unit area. When a user presses a microphone shape in the right upper corner of the screen of FIG. 6, the screen is switched over to the one shown in FIG. 7. And, if the user utters the pronunciation of “American”, the system presents the screen of FIG. 8 as a result of the input and the speech recognition. That is, the search result is for a Korean word “ [symbol] ”. However, if the user wanted to input as an English word “American” speech input is impossible. Because, only an input of a default system language is available.

At this time, the process for inputting “American' is now described as an embodiment of the present invention with reference to the accompanying drawings.

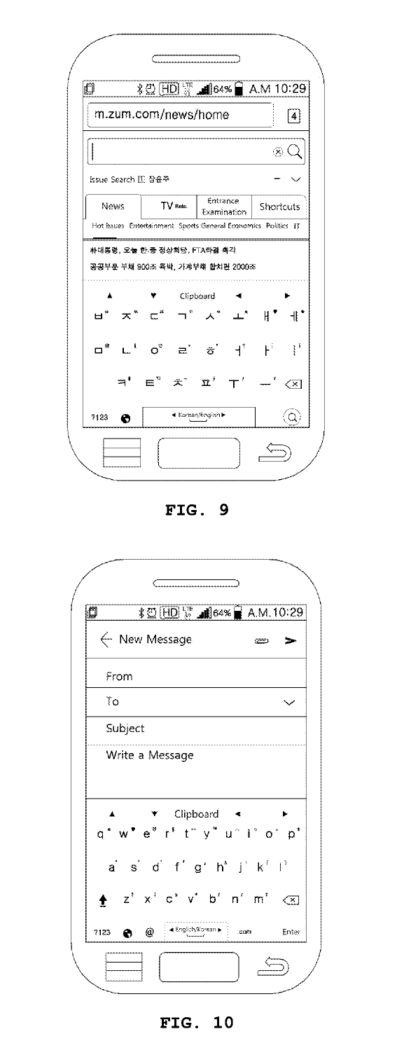

First, FIGS. 9 and 10 illustrate an embodiment in which a virtual keyboard is provided with a virtual keyboard layout such as Korean/English switch key, symbol switch key, number switch key, and so on. In some cases, a modified embodiment designed to display the Korean/English switch key, symbol switch key, number switch key, and so on in the same screen is available. If a user tries to input “American” in English, he or she can change the input language to the English input mode by input of “Korean/English switch” and then uttering “American”.

The memory unit stores a database in which an identification voice data is assigned and mapped to each of the execution unit areas on the screen displayed through the display unit, i.e. to each of the GUIs which is a key of the English QWERTY keyboard in FIG. 10. Specifically, a database in which an identification voice data is assigned and mapped by a phonemic unit according to the speech synthesis rules for each of the execution unit areas. Here a plurality of the identification voice data by a phoneme are stored, and, according to the above-described speech synthesis rules, the identification voice data by a phoneme can be selected and used when the user's speech is divided by a phoneme, compared, and determined by the formation processing unit, which will be described later.

And, when the speech recognition unit receives an input of a user's speech, the information processing; unit searches the database and determines whether there is an identification voice data corresponding to the user's speech. At this time, the information processing unit divides the received user's speech by a phoneme and compares it in the database of the memory unit.

Accordingly, as a result of the determination of the information processing unit, if there is an identification voice data corresponding to the user's speech, the control unit generates an input signal to the execution unit area to which the corresponding identification voice data is assigned.

2. A method of voice control of a display device

The present invention also provides a method of voice control of a display device which is performed in a voice-controlled display device comprising a display unit, a memory unit, a speech recognition unit, an information processing unit, and a control unit and which comprises the steps of:

(a) storing a database in which an identification voice data for each of execution unit areas on a screen displayed through the display unit is assigned and mapped by the memory unit; (b) if there is text for each of the execution unit areas on the screen displayed through the display unit, generating an identification voice data through a text-based speech synthesis using the text by the information processing unit; (c) receiving an input of speech of a user by the speech recognition unit; (d) searching the database and determining whether there is identification voice data corresponding to the user's speech by the information processing unit; and (e) if there is identification voice data corresponding to the user's speech according to a result of the determination by the information processing unit, generating an execution signal in the execution unit area to which the corresponding identification voice data is assigned by the control unit.

The step (a) is a step of building a database by the memory unit, and, in the database, identification voice data is assigned and mapped to each of the execution unit areas on the screen displayed through the display unit. Specifically, it includes unique coordinate information given by area which is recognized as the same execution unit area on the screen. The identification voice data can be generated in the step (b).

The step (c) is a step of receiving an input of a speech of a user by the speech recognition unit. This step is performed in the state that the voice-controlled display device is switched to a speech recognition mode.

The step (d) is a step of searching the database and determining whether there is identification voice data corresponding to the user's speech by the information processing unit. Specifically, the information processing unit detects unique coordinate information of the execution unit area to which the corresponding identification voice data is assigned if there is identification voice data corresponding to the user's speech.

The step (e) is a step of generating an execution signal in the execution unit area to which the corresponding identification voice data is assigned by the control unit if there is identification voice data corresponding to the user's speech according to a result of the determination by the information processing unit. In this step, the control unit serves to generate an execution signal in the execution unit area to which the corresponding identification voice data is assigned if there is identification voice data corresponding to the user's speech according to a result of the determination by the information processing unit, and it generates the execution signal in the area on the screen having the coordinate information detected by the information processing unit. The result of the generation of the execution signal differs according to the content in the execution unit area if a shortcut icon of the specific application is present in the execution unit area the application is executed. If a specific character of a virtual keyboard is present in the execution unit area, then the specific character is inputted. If a command such as screen switchover is assigned to the execution unit area, the command is performed.

Meanwhile, in the method of voice control of the display device according to the present invention, the step (a) is performed in a manner that a database which additionally includes a control voice data corresponding to a control command for performing a specific screen control and an execution control which correspond to the execution unit area to which the identification voice data is assigned if his combined and used with the identification voice data is stored, the step (d) is performed in a manner that the information processing unit searches the database and determines whether there are identification voice data and control voice data corresponding to the user's speech, and the step (e) is performed in a manner that, if it is determined that there are identification voice data and control voice data corresponding to the user's speech according to the determination result of the information processing unit, the control unit generates an execution signal to the execution unit area to which the corresponding identification voice data is assigned and also executes a control command corresponding to the control voice data which corresponds to the execution unit area which generated the execution signal. The specific embodiment related thereto is the same as described with reference to FIGS. 3 and 4.

A voice-controlled display device and a method of voice control of the display device according to the present invention are characterized in that: it is a technology which enables convenient and accurate voice control by applying a conventional touchscreen type input control method to the voice control method as it is in a manner that an input control is performed by comparing the input user speech with the identification voice data assigned for each of the execution unit areas on the screen displayed through the display unit; it does not need to store the identification voice data in advance or record the user's speech since the identification voice data is generated on the basis of the text displayed on the screen through a text-based speech synthesis; it supports newly downloaded and installed applications as well as the existing embedded applications; and it supports voice control by various languages by only installing a language pack for the text-based speech synthesis to the voice-controlled display device of the present invention.

A program code for performing the above-described method of voice control of the display device may be recorded on a recording medium of various types. Accordingly, if a recording medium with the above-described program code recorded thereon is connected or mounted to a voice-controlled display device, the above-described method of voice control of the display device may be supported.

The voice-controlled display device and the method of voice control of the display device according to the present invention are described in detail with specific embodiments, but the present invention is not limited to the above specific embodiments. Rather, various changes and modifications can be made to the invention without departing from the scope of the present invention. Therefore, any modification, equivalent replacement and improvement that are made within the spirit and principle of the invention should be included within the scope of the present invention.

What is claimed is:

1. A voice-controlled display device which comprises:
a display unit: and
a memory unit with a database, in which an identification voice data, stored thereon, is assigned and mapped to each of execution unit areas on a screen displayed through the display unit.

2. The voice-controlled display device of claim 1, further comprising:
an information processing unit for generating the identification voice data through a text-based speech synthesis using text, in the case that there exists text for each of the execution unit areas on the screen displayed through the display unit.

3. The voice-controlled display device of claim 1, further comprising:
a communication unit connectable to the Internet;
wherein, in the case that a new application including identification voice data is downloaded and installed in the display device, the display unit generates an execution unit area for the newly installed application, the identification voice data included in the application is classified in the information processing unit, and the database stored in the memory unit stores the generated execution unit area and the distinguished identification voice data which are assigned and mapped.

4. The voice-controlled display device of claim 1, further comprising:
a speech recognition unit for receiving input user's speech, wherein, in the case that the speech recognition unit receives user's speech, the information processing unit searches the database and determines whether there exists an identification voice data corresponding to the user's speech; and
a control unit for generating an execution signal for a corresponding execution unit area in the case that there exists an identification voice data corresponding to the user's speech as a result of the determination of the information processing unit.

5. The voice-controlled display device of claim 2, further comprising:
a speech recognition unit for receiving input user's speech, wherein, in the case that the speech recognition unit receives a user's speech, the information processing unit searches the database and determines whether there exists an identification voice data corresponding to the user's speech; and
a control unit for generating an execution signal for a corresponding execution unit area in the case that there exists an identification voice data corresponding to the user's speech as a result of the determination of the information processing unit.

6. The voice-controlled display device of claim 2, wherein the identification voice data generated by the information processing unit is generated by applying a speech synthesis modeling information based on user utterance.

7. The voice-controlled display device of claim 4, wherein:
a control voice data corresponding to a control command for performing a specific screen control and an execution control corresponding to the execution unit area, to which an identification voice data is assigned if it is combined and used with the identification voice data, is stored additionally in the database;
in the case that the speech recognition unit receives a user's speech, the information processing unit searches the database and determines whether there exist an identification voice data and a control voice data corresponding to the user's speech; and
in the case that there exist an identification voice data and a control voice data corresponding to the user's speech as a result of the determination of the information processing unit, the control unit generates an execution signal in an execution unit area to which the corresponding identification voice data is assigned and executes the control command corresponding to the control voice data corresponding to the execution unit area which generated the execution signal.

8. The voice-controlled display device of claim 5, wherein:
a control voice data corresponding to a control command for performing a specific screen control and an execution control corresponding to the execution unit area, to which an identification voice data is assigned if it is combined and used with the identification voice data, is stored additionally in the database:
in the case that the speech recognition unit receives a uses speech, the information processing unit searches the database and determines whether there exist an identification voice data and a control voice data corresponding to the user's speech; and
in the case that there exist an identification voice data and a control voice data corresponding to the user's speech as a result of the determination of the information processing unit, the control unit generates an execution signal in an execution unit area to which the corresponding identification voice data is assigned and executes the control command corresponding to the control voice data corresponding to the execution unit area which generated the execution signal.

9. The voice-controlled display device of claim 2, wherein the identification voice data stored in the memory unit is stored by phoneme.

10. The voice-controlled display device of claim 5, wherein, when the information processing unit determines that there exists an identification voice data corresponding to the user's speech, the received user's speech is divided by phoneme and compared.

11. A method of voice control of a voice-controlled display device comprising a display unit, a memory unit, a speech recognition mat, an information processing unit and a control unit, which comprises the step of:
(a) storing a database in which an identification voice data is assigned and mapped to each of execution unit areas on a screen displayed through the display unit in the memory unit.

12. The method of voice control of a voice-controlled display device of claim 11, further comprising the step of:
(b) generating an identification voice data through a text-based speech synthesis using text in the case that there exists text for each of the execution unit areas on the screen displayed through the display unit by the information processing unit.

13. The method of voice control of a voice-controlled display device of claim 11, wherein:
the voice-controlled display device further comprises a communication unit connectable to the Internet; and,
in the case that a new application including identification voice data is downloaded and installed in the display device, the method further comprises the steps of:
generating an execution unit area for the newly installed application by the display unit;
distinguishing the identification voice data included in the application by the information processing unit; and
storing the generated execution unit area and the distinguished identification voice data which are assigned and mapped in the database stored in the memory unit.

14. The method of voice control of a voice-controlled display device of claim 11, further comprising the steps of:
(c) receiving an input of a user's speech by the speech recognition unit;
(d) searching the database and determining whether there exists an identification voice data corresponding to the user's speech by the information processing unit; and
(e) generating an execution signal for the execution unit area to which the corresponding identification voice data is assigned by the control unit in the case that there exists an identification voice data corresponding to the user's speech as a result of the determination of the information processing unit.

15. The method of voice control of a voice-controlled display device of claim 12, further comprising the steps of:
(c) receiving an input of a user's speech by the speech recognition unit;
(d) searching the database and determining whether there exists an identification voice data corresponding to the user's speech by the information processing unit; and
(e) generating an execution signal for the execution unit area to which the corresponding identification voice data is assigned by the control unit in the case that there exists an identification voice data corresponding to the user's speech as a result of the determination of the information processing unit.

16. The method of voice control of a voice-controlled display device of claim 12, wherein the identification voice data generated by the information processing unit is generated by applying a speech synthesis modeling information based on an user utterance.

17. The method of voice control of a voice control display device of claim 14, wherein:
the step (a) is performed such that a control voice data corresponding to a control command for performing a specific screen control and an execution control corresponding to the execution unit area, to which an identification voice data is assigned if it is combined and used with the identification voice data, is stored additionally in the database in the memory unit;
the step (d) is performed such that the information processing unit searches the database and determines whether there exist an identification voice data and a control voice data corresponding to the user's speech; and
the step (e) is performed such that, in the case that there exist an identification voice data and a control voice data corresponding to the user's speech as a result of the determination of the information processing unit, the control unit generates an execution signal in an execution unit area to which the corresponding identification voice data is assigned and executes the control command corresponding to the control voice data corresponding to the execution unit area which generated the execution signal.

18. The method of voice control of a voice-controlled display device of claim 15, wherein:
the step (a) is performed such that a control voice data corresponding to a control command for performing a specific screen control and an execution control corresponding to the execution unit area, to which an identification voice data is assigned if it is combined and used with the identification voice data, is stored additionally in the database in the memory unit;
the step (d) is performed such that the information processing unit searches the database and determines whether there exist an identification voice data and a control voice data corresponding to the user's speech; and
the step (e) is performed such that, in the case that there exist an identification voice data and a control voice data corresponding to the user's speech as a result of the determination of the information processing unit, the control unit generates an execution signal in an execution unit area to which the corresponding identification voice data is assigned and executes the control command corresponding to the control voice data corresponding to the execution unit area which generated the execution signal.

19. The method of voice control of a voice-controlled display device of claim 12, wherein the identification voice data stored in the memory unit in the step (a) is by phoneme.

20. The method of voice control of a voice-controlled display device of claim 15, wherein, when the information processing unit determines that there exists an identification voice data corresponding to the user's speech in the step (d), the received user's speech is divided by phoneme and compared.
